(19) United States
(12) Patent Application Publication
(10) Pub. No.: US 2025/0351860 A1
(43) Pub. Date: Nov. 20, 2025

(54) PRESERVING VITAMIN IN A NUTRITIONAL COMPOSITION

(71) Applicant: NUTRICIA EARLY LIFE NUTRITION (SHANGHAI) CO., LTD., Shanghai (CN)

(72) Inventors: Xiao ZHANG, Shanghai (CN); Ye TAO, Shanghai (CN); Leilei SHEN, Shanghai (CN); Haofang JIN, Shanghai (CN)

(73) Assignee: NUTRICIA EARLY LIFE NUTRITION (SHANGHAI) CO., LTD., Shanghai (CN)

(21) Appl. No.: 19/287,855

(22) Filed: Aug. 1, 2025

Related U.S. Application Data
(63) Continuation of application No. PCT/IB2024/051091, filed on Feb. 6, 2024.

(30) Foreign Application Priority Data
Feb. 6, 2023 (WO) PCT/CN2023/074549

(51) Int. Cl. A23L 33/00; A23B 2/775; A23L 33/15; A23L 33/155

(52) U.S. Cl. CPC A23L 33/40; A23B 2/775; A23L 33/15; A23L 33/155

(57) ABSTRACT

The present invention relates to preserving vitamin in a nutritional composition during shelf-life.

### FIELD OF THE INVENTION

The present invention relates to preserving vitamin in a nutritional composition for infants and young children.

### BACKGROUND OF THE INVENTION

Storage stability of vitamins in nutritional compositions is a known issue in food technology, especially in nutritional compositions such as infant milk formula. In such products, in order to stay within the required vitamin levels during the complete shelf-life, higher levels of vitamin are added in order to compensate for the loss in vitamin during storage. The reduction of vitamin levels during storage is relatively high compared to other nutrients present in such nutritional compositions.

Human milk lipids are known to have a distinct physical structure composed of large lipid globules with a mode diameter, based on volume, of about 4 μm existing of a triglyceride core coated by a tri-layer of membranes, the milk fat globule membrane (MFGM). The mode diameter, based on volume, of lipid globules in standard infant formula is typically about 0.3-0.5 μm due to the industrial processing procedures applied to achieve stable and reproducible products, and the lipid globules are not surrounded by MFGM but mostly by milk proteins. Infant formula with lipid globules with an architecture more similar to the lipid globules in human milk have been described (e.g. WO2010/027258 or WO2010/027259).

WO2014/143523 describes a lipid source for nutritional compositions, comprising an enriched lipid fraction which comprises structured fat globules. The enriched lipid fraction provides fat globules having a desired size and fatty acid composition and may be stabilized by components such as phospholipids, cholesterol, milk-fat globule membrane protein and combinations thereof.

WO2010/068103 describes a nutritional composition for infants and/or toddlers comprising a lipid component which has a lipid globules coated with phospholipids. The composition is used for increasing bone mineral content, bone mineral density, preventing osteoporosis, and/or preventing osteopenia.

The above disclosures describe the presence of vitamins in the nutritional compositions described therein, however they do not relate to storage stability of vitamins.

US2015/079265A1 describes a process for preparing a spray-dried lipid and protein component-containing composition comprising large lipid globules by applying an atomization system employing a two-fluid nozzle.

U.S. Pat. No. 11,358,161B2 describes a process for preparing a spray-dried lipid and protein component-containing composition comprising large lipid globules by applying an atomization system employing a rotary atomizer.

US2022/175675A1 describes methods of encapsulating molecules, such as vitamin D and curcumin, in milk fat globules and oleosomes and compositions comprising molecules encapsulated in milk fat globules and oleosomes.

### SUMMARY OF THE INVENTION

The inventors of the present invention have surprisingly found that the storage stability of vitamins in a nutritional composition, such as infant formula, is improved by increasing the size of the lipid globules in the nutritional composition and by coating these lipid globules with mammalian derived phospholipids. Compared to a similar nutritional composition with smaller lipid globules and no phospholipid coating, the levels of vitamins reduced considerably less in accelerated storage conditions, i.e. the vitamin stability was improved.

This is advantageous, as a lower concentration of vitamin can be added to the nutritional composition, while still staying above the minimally required levels of vitamin, in for example infant formula, during the complete shelf-life of the nutritional composition. Moreover, less or no additives are needed for stabilizing the vitamins. The present invention thus provides an efficient and environmental-friendly solution for better preserving vitamins in nutritional compositions.

Thus, the present invention relates to the use of phospholipid coated lipid globules for improving vitamin stability during shelf-life in a nutritional composition selected from infant formula, follow-on formula or young child formula, said composition comprising digestible carbohydrates, protein, lipid and vitamins, wherein the lipid is in the form of lipid globules; and
i. wherein the lipid globules have a mode diameter, based on volume, of at least 1.0 μm; and/or at least 45 volume %, based on total lipid volume, of the lipid globules have a diameter of 2 to 12 μm; and
ii. wherein the lipid comprises 0.5 to 20 wt. % phospholipids based on total lipids and wherein the lipid globules are at least partly coated on the surface with phospholipids derived from mammalian milk; and
   wherein the nutritional composition comprises 10-50 wt. % vegetable lipid by weight of dry matter.

The invention also relates to a nutritional composition, wherein the nutritional composition is selected from infant formula, follow-on formula and young child formula, wherein the nutritional composition comprises digestible carbohydrates, protein, lipid and vitamins, wherein the lipid is in the form of lipid globules and wherein
a. the lipid globules have a mode diameter, based on volume, of at least 1.0 μm; and/or at least 45 volume %, based on total lipid volume, of the lipid globules have a diameter of 2 to 12 μm; and
b. wherein the lipid comprises 0.5 to 20 wt. % phospholipids based on total lipids and wherein the lipid globules are at least partly coated on the surface with phospholipids;
c. wherein the nutritional composition comprises 10-50 wt. % vegetable lipid by weight of dry matter; and
d. wherein the nutritional composition comprises the following shelf-life stable vitamins
   i. 10-50 μg RE/100 kJ vitamin A;
   ii. 0.1-1.5 μg/100 kJ vitamin D;
   iii. 0.05-1.5 mg a-tocopherol/100 kJ vitamin E
   iv. 1-80 μg/100 kJ vitamin B1;
   v. 50-550 μg/100 kJ vitamin B5;
   vi. 1-15 μg/100 kJ vitamin B9; and
   vii. 0.01-0.5 μg/100 kJ vitamin B12.

### DETAILED DESCRIPTION

A first aspect of the invention relates to the use of lipid globules for improving vitamin stability in a nutritional composition comprising digestible carbohydrates, protein, lipid and vitamins, wherein the lipid is in the form of lipid globules; and wherein the lipid globules have a mode diameter, based on volume, of at least 1.0 μm; and/or at least 45 volume %, based on total lipid volume, of the lipid globules have a diameter of 2 to 12 μm.

More preferably, the first aspect of the invention relates to the use of phospholipid coated lipid globules for improving vitamin stability during shelf-life in a nutritional composition selected from infant formula, follow-on formula or young child formula, said composition comprising digestible carbohydrates, protein, lipid and vitamins, wherein the lipid is in the form of lipid globules; and
i. wherein the lipid globules have a mode diameter, based on volume, of at least 1.0 μm; and/or at least 45 volume %, based on total lipid volume, of the lipid globules have a diameter of 2 to 12 μm; and
ii. wherein the lipid comprises 0.5 to 20 wt. % phospholipids based on total lipids and wherein the lipid globules are at least partly coated on the surface with phospholipids derived from mammalian milk; and
   wherein the nutritional composition comprises 10-50 wt. % vegetable lipid by weight of dry matter.

The term ‘shelf-life’ as used herein refers to the storage of the nutritional composition in an airtight packaging at a temperature of 10-30° C. Preferably for a period of at least 2 months, more preferably for a period at least 4 months, and most preferably for a period of 6-24 months.

Preferably, the nutritional composition is airtight packaged, more preferably the nutritional composition is airtight packaged in a packaging with a volume 100-1500 ml, and most preferably the nutritional composition is airtight packaged in a packaging with a volume of 200-1000 ml.

The nutritional composition is preferably selected from infant formula, follow-on formula or young child formula. The nutritional composition is preferably an infant formula or a follow-on formula. More preferably the nutritional composition is an infant formula. Therefore, the nutritional composition is preferably not human milk or native milk from another mammal. Also, the nutritional composition is preferably artificially made or in other words synthetic.

In the present invention, infant formula refers to nutritional compositions, artificially made, intended for infants of 0 to about 4 to 6 months of age and are intended as a substitute for human milk. Typically, infant formulae are suitable to be used as sole source of nutrition. Such infant formulae are also known as starter formula. Follow-on formula for infants starting with at 4 to 6 months of life to 12 months of life are intended to be supplementary feedings for infants that start weaning on other foods. Infant formulae and follow-on formulae are subject to strict regulations, for example for the EU regulations no. 609/2013 and no. 2016/127, and CN regulations such as GB 10765-2021 (infant formula) and GB 10766-2021 (follow-on formula). In the present context, young child formula refers to nutritional compositions, artificially made, intended for infants of 12 months to 36 months, which are intended to be supplementary feedings for infants. In the context of the present invention, young child formula may also be named growing-up milk.

Preferably the nutritional composition is an infant formula, follow-on formula or young child formula, and has an energy density of 60 to 75 kcal/100 ml, more preferably 60 to 70 kcal/100 ml, when in a ready-to-drink form. This density ensures an optimal balance between hydration and caloric intake.

Preferably the nutritional composition is an infant formula, follow-on formula or young child formula, wherein the lipid preferably provides 30 to 60% of the total calories, the protein provides 5 to 20% of the total calories and the digestible carbohydrates provide 25 to 75% of the total calories.

Preferably the nutritional composition is an infant formula, follow-on formula or young child formula, and comprises 5 to 20g digestible carbohydrates/100 kcal, more preferably 6 to 16 g digestible carbohydrates/100 kcal, most preferably 10 to 15 g digestible carbohydrates/100 kcal, and comprises 1.7 to 3.5 g protein/100 kcal, more preferably 1.8 to 2.1 g protein/100 kcal, most preferably 1.8 to 2.0 g protein/100 kcal and comprises 3 to 7 g lipid/100 kcal, more preferably 4 to 6 g lipid/100 kcal, most preferably 4.5 to 5.5 g lipid/100 kcal.

### Lipid

The nutritional composition comprises lipid. Lipid in the present invention comprises one or more selected from the group consisting of triglycerides, polar lipids (such as phospholipids, cholesterol, glycolipids, sphingomyelin), free fatty acids, monoglycerides and diglycerides. Preferably the composition comprises at least 70 wt. %, more preferably at least 80 wt. %, even more preferably at least 85 wt. % triglycerides, most preferably at least 90 wt. % triglycerides based on total lipid.

The lipid provides preferably 30 to 60% of the total calories of the nutritional composition. More preferably the nutritional composition comprises lipid providing 35 to 55% of the total calories, even more preferably the nutritional composition comprises lipid providing 40 to 50% of the total calories. The lipid is preferably present in an amount of 3 to 7g per 100 kcal, more preferably in an amount of 4 to 6g lipid per 100 kcal and most preferably in an amount of 4.5 to 5.5g lipid per 100 kcal. When in liquid form, e.g. as a ready-to-feed liquid, the nutritional composition preferably comprises 2.1 to 6.5g lipid per 100 ml, more preferably 3.0 to 4.0g per 100 ml. Based on dry weight the nutritional composition preferably comprises 10 to 50 wt. %, more preferably 12.5 to 40 wt. % lipid, even more preferably 19 to 30 wt. % lipid.

The lipid preferably comprises vegetable lipid. The presence of vegetable lipid advantageously enables an optimal fatty acid profile high in polyunsaturated fatty acids and/or more reminiscent to human milk fat. Lipid from mammalian milk alone, e.g. cow milk, does not provide an optimal fatty acid profile. The amount of essential fatty acids is too low in non-human mammalian milk.

Preferably the nutritional composition comprises at least one, preferably at least two vegetable lipid sources selected from the group consisting of linseed oil (flaxseed oil), rape seed oil (such as colza oil, low erucic acid rape seed oil and canola oil), sunflower oil, high oleic sunflower oil, safflower oil, high oleic safflower oil, olive oil, coconut oil, palm oil and palm kernel oil.

In a preferred embodiment, the nutritional composition comprises 30 to 100 wt. % vegetable lipid based on total lipid, more preferably 35 to 85 wt. %, even more preferably 40 to 70 wt. %, and most preferably 40 to 60 wt. % vegetable lipid based on total lipid.

The lipid in the nutritional composition preferably further comprises mammalian milk fat, preferably ruminants milk fat, more preferably the mammalian milk fat is derived from cow milk, goat milk, sheep milk, buffalo milk, yak milk, reindeer milk, and/or camel milk, most preferably the mammalian milk fat is cow milk fat. Preferably the mammalian milk fat is not human milk fat.

Preferably the mammalian milk fat is derived from butter, butter fat, butter oil, and/or anhydrous milk fat, more preferably the mammalian milk fat is derived from anhydrous milk fat and/or butter oil. Such mammalian milk fat sources are high in triglyceride levels.

Preferably the nutritional composition comprises 0 to 70 wt. % mammalian milk fat based on total lipid, more preferably 15 to 65 wt. %, even more preferably 30 to 60 wt. %, and most preferably 40 to 60 wt. % mammalian milk fat based on total lipid.

The nutritional composition preferably also comprises one or more of fish oil, egg lipid, and microbial, algal, fungal or single cell oils.

Compared to vegetable fat, mammalian milk fat is known to have a higher content of palmitic acid (PA) at the sn-2 position of a triglyceride. PA relates to palmitic acid and/or acyl chains (C16:0). In a preferred embodiment, the lipid in the nutritional composition comprises at least 10 wt. % PA based on total fatty acids and at least 15 wt. % of PA, based on total palmitic acid, is located at the sn-2 position of a triglyceride. Preferably, the amount of PA is below 30 wt. % based on total fatty acids. More preferably, the amount of PA is from 12 to 26 wt. % based on total fatty acids, even more preferably from 14 to 24 wt. %.

Preferably, at least 15 wt. % PA, more preferably at least 20 wt. % PA, even more preferably at least 25 wt. % PA, most preferably at least 30 wt. % PA, based on total PA, is in the sn-2 or beta position in a triglyceride. Preferably the amount of PA in the sn-2 position in a triglyceride is not more than 45 wt. %, preferably not more than 40 wt. % based on total PA present in the lipid. Preferably the amount of PA in the sn-2 position in a triglyceride is from 25 to 40 wt. % based on total PA.

Compared to vegetable fat, mammalian milk fat is known to have a higher content of short-chain fatty acids (SCFA) butyric acid (BA; C4:0) and caproic acid (CA; C6:0). In a preferred embodiment, the lipid in the nutritional composition comprises 0.6 to 5 wt. % SCFA being the sum of BA and CA based on total fatty acids. Preferably the nutritional composition comprises less than 5 wt. % BA based on total fatty acids, preferably less than 4 wt. %. Preferably the nutritional composition comprises at least 0.5 wt. % BA based on total fatty acids, preferably at least 0.6 wt. %, preferably at least 0.9 wt. %, more preferably at least 1.2 wt. % BA based on total fatty acids.

In a preferred embodiment, the lipid in the nutritional composition comprises: .
at least 10 wt. % PA based on total fatty acids and at least 15 wt. % of PA, based on total PA, is located at the sn-2 position of a triglyceride; and.
0.6 to 5 wt. % SCFA being the sum of BA and CA based on total fatty acids.

### Fatty Acid Composition

SFA relates to saturated fatty acids and/or acyl chains, MUFA relates to mono-unsaturated fatty acid and/or acyl chains, PUFA refers to polyunsaturated fatty acids and/or acyl chains with 2 or more unsaturated bonds; LC-PUFA refers to long chain polyunsaturated fatty acids and/or acyl chains comprising at least 20 carbon atoms in the fatty acyl chain and with 2 or more unsaturated bonds; n3 or omega-3 PUFA refers to polyunsaturated fatty acids and/or acyl chains with 2 or more unsaturated bonds with an unsaturated bond at the third carbon atom from the methyl end of the fatty acyl chain, n6 or omega-6 PUFA refers to polyunsaturated fatty acids and/or acyl chains with 2 or more unsaturated bonds with an unsaturated bond at the sixth carbon atom from the methyl end of the fatty acyl chain.

In the context of the present invention, a weight percentage of fatty acids based on total fatty acids is calculated as if all fatty acids are free fatty acids, hence it is not taken into account whether a fatty acid is attached to a glycerol backbone or not.

DHA refers to docosahexaenoic acid and/or acyl chain (22:6 n3); DPA refers to docosapentaenoic acid and/or acyl chain (22:5 n3); n6 DPA refers to omega-6 docosapentaenoic acid and/or acyl chain (22:5 n6). EPA refers to eicosapentaenoic acid and/or acyl chain (20:5 n3); ARA refers to arachidonic acid and/or acyl chain (20:4 n6). LA refers to linoleic acid and/or acyl chain (18:2 n6); ALA refers to alpha-linolenic acid and/or acyl chain (18:3 n3).

LA refers to linoleic acid and/or acyl chain and is an n6 PUFA (18:2 n6) and the precursor of n6 LC-PUFA and is an essential fatty acid as it cannot be synthesized by the human body. The nutritional composition preferably comprises LA. LA preferably is present in a sufficient amount to promote a healthy growth and development, yet in an amount as low as possible to prevent negative, competitive, effects on the formation of n3 PUFA and a too high n6/n3 ratio. The nutritional composition therefore preferably comprises less than 20 wt. % LA based on total fatty acids, preferably 5 to 16 wt. %, more preferably 10 to 14.5 wt. %. Preferably, the nutritional composition comprises at least 5 wt. % LA based on total fatty acids, preferably at least 6 wt. % LA, more preferably at least 7 wt. % LA based on total fatty acids. Per 100 kcal, the nutritional composition preferably comprises 350-1400 mg LA.

ALA refers to alpha-linolenic acid and/or acyl chain and is an n3 PUFA (18:3 n3) and the precursor of n3 LC-PUFA and is an essential fatty acid as it cannot be synthesized by the human body. The nutritional composition preferably comprises ALA. Preferably ALA is present in a sufficient amount to promote a healthy growth and development of the infant. The nutritional composition preferably comprises at least 1.0 wt. %, more preferably the nutritional composition comprises at least 1.5 wt. %, even more preferably at least 2.0 wt. % ALA based on total fatty acids. Preferably the nutritional composition comprises less than 10 wt. % ALA, more preferably less than 5.0 wt. %, based on total fatty acids.

Preferably the nutritional composition comprises a weight ratio of LA/ALA from 2 to 20, more preferably from 3 to 16, even more preferably from 4 to 14, most preferably from 5 to 12.

The lipid in the nutritional composition preferably comprises 5 to 35 wt. % PUFA, based on total fatty acids, comprising LA and ALA in a weight ratio LA/ALA of 2 to 20.

Preferably, the nutritional composition comprises n3 LC-PUFA, such as EPA, DPA and/or DHA, more preferably DHA. As the conversion of ALA to DHA may be less efficient in infants, preferably both ALA and DHA are present in the nutritional composition. Preferably the nutritional composition comprises at least 0.05 wt. %, preferably at least 0.1 wt. %, more preferably at least 0.2 wt. %, of DHA based on total fatty acids. Preferably the nutritional composition comprises not more than 2.0 wt. %, preferably not more than 1.0 wt. % of DHA based on total fatty acids.

The nutritional composition preferably comprises ARA. Preferably the nutritional composition comprises at least 0.05 wt. %, preferably at least 0.1 wt. %, more preferably at least 0.2 wt. % of ARA based on total fatty acids. As the group of n6 fatty acids, especially arachidonic acid (ARA) counteracts the group of n3 fatty acids, especially DHA, the nutritional composition preferably comprises relatively low amounts of ARA. Preferably the nutritional composition comprises not more than 2.0 wt. %, preferably not more than 1.0 wt. % of ARA based on total fatty acids. Preferably the weight ratio between DHA and ARA is between 1:4 to 4:1, more preferably between 1:2 to 2:1, more preferably between 0.6 and 1.5.

### Lipid Globule Size

The lipid in the nutritional composition is in the form of lipid globules and wherein:
a. the lipid globules have a mode diameter, based on volume, of at least 1.0 μm; and/or
b. at least 45 volume %, based on total lipid volume, of the lipid globules have a diameter of 2 to 12 μm.

When the nutritional composition is in liquid form, these lipid globules are emulsified in the aqueous phase. Alternatively, when the nutritional composition is in powder form, the lipid globules are present in the powder and the powder is suitable for reconstitution with water or another food grade aqueous phase. The lipid globules comprise a core and a surface.

The lipid globules in the nutritional composition preferably have mode diameter, based on volume, of at least 1.0 μm, more preferably at least 2.0 μm, and most preferably at least 3.0 μm. Preferably, the lipid globules have a mode diameter, based on volume, between 1.0 and 10 μm, more preferably between 1.5 and 8.0 μm, even more preferably between 2.0 and 7.0 μm, and most preferably between 3.0 μm and 6.0 μm.

Alternatively, or preferably in addition, the size distribution of the lipid globules is preferably in such a way that at least 45 volume % (vol.%), preferably at least 55 vol. %, even more preferably at least 65 vol. %, and most preferably at least 75 vol. % of the lipid globules have a diameter between 2 and 12 μm. In a more preferred embodiment, at least 45 vol. %, preferably at least 55 vol. %, more preferably at least 65 vol. %, and most preferably at least 75 vol. % of the lipid globules have a diameter between 2 and 10 μm. In an even more preferred embodiment, at least 45 vol. %, more preferably at least 55 vol. %, yet even more preferably at least 65 vol. %, and most preferably at least 75 vol. % of the lipid globules have a diameter between 4 and 10 μm. Preferably less than 5 vol. % of the lipid globules have a diameter above 12 μm.

Standard infant formulas, follow-on formulas or young child formulas typically have lipid globules with a mode diameter, based on volume, of 0.3-0.5 μm and/or less than 45 vol. % of the lipid globules have a diameter above 2 μm.

The volume percentage of lipid globules is based on volume of total lipid. The mode diameter relates to the diameter which is the most present based on volume % of total lipid, or the peak value in a graphic representation, having on the X-as the diameter and on the Y-as the volume %.

The volume of the lipid globule and its size distribution can suitably be determined using a particle size analyzer such as a Mastersizer 2000 (Malvern Instruments, Malvern, UK), for example by the method described in Michalski et al, 2001, Lait 81:787-796.

### Phospholipid

The nutritional composition preferably comprises 0.5 to 20 wt. % phospholipid based on total lipid, preferably 0.6 to 10 wt. %, even more preferably 0.7 to 8 wt. %, even more preferably 0.8 to 8 wt. %, and most preferably 1 to 5 wt. % phospholipid based on total lipid.

In a preferred embodiment the lipid globules are at least partly coated on the surface with phospholipids.

By ‘coating’ is meant that the outer surface layer of the lipid globules comprises phospholipid, whereas phospholipid is virtually absent in the core of the lipid globule. A suitable way to determine whether phospholipid is located on the surface of lipid globules is confocal laser scanning microscopy or transmission electron microscopy; see for instance Gallier et al. (A novel infant milk formula concept: Mimicking the human milk fat globule structure, Colloids and Surfaces B: Biointerfaces 136 (2015) 329-339).

The nutritional composition preferably comprises Examples glycerophospholipids. of glycerophospholipids are phosphatidylcholine (PC), phosphatidylserine (PS), phosphatidylethanolamine (PE), phosphatidylinositol (PI) and phosphatidylglycerol (PG). Preferably the nutritional composition comprises one or more of PC, PS, PI and PE, more preferably the nutritional composition comprises at least PC.

The nutritional composition preferably comprises sphingomyelin. Sphingomyelins have a phosphorylcholine or phosphorylethanolamine molecule esterified to the 1-hydroxy group of a ceramide. They are classified as phospholipid as well as sphingolipid, but are not classified as a glycerophospholipid nor as a glycosphingolipid. Preferably the nutritional composition comprises 0.05 to 10 wt. % sphingomyelin based on total lipid, more preferably 0.1 to 5 wt. %, even more preferably 0.2 to 2 wt. % based on total lipid. Preferably the nutritional composition comprises at least 5 wt. %, more preferably 5 to 40 wt. % sphingomyelin based on total phospholipid, more preferably 10 to 35 wt. %, even more preferably 15 to 35 wt. %, based on total phospholipid.

The nutritional composition preferably comprises glycosphingolipids. Preferably the nutritional composition comprises 0.1 to 10 wt. % glycosphingolipids based on total lipid, more preferably 0.5 to 5 wt. %, even more preferably 2 to 4 wt. %, based on total lipid. The term glycosphingolipids in the present context particularly refers to glycolipids with an amino alcohol sphingosine. The sphingosine backbone is O-linked to a charged head-group such as ethanolamine, serine or choline backbone. The backbone is also amide linked to a fatty acyl group. Glycosphingolipids are ceramides with one or more sugar residues joined in a beta-glycosidic linkage at the 1-hydroxyl position, and include gangliosides. Preferably the nutritional composition contains gangliosides, more preferably at least one ganglioside selected from the group consisting of GM3 and GD3.

The nutritional composition preferably comprises phospholipid derived from mammalian milk. Preferably the nutritional composition comprises phospholipid and glycosphingolipid derived from mammalian milk. The nutritional composition preferably comprises phospholipid and optionally glycosphingolipid from mammalian milk from cows, mares, sheep, goats, buffalos, horses and/or camels. More preferably the nutritional composition comprises phospholipid and optionally glycosphingolipid from cow's milk.

Phospholipid derived from milk includes preferably phospholipid that is isolated from milk fat, cream lipid, cream serum lipid, butter serum lipid (beta serum lipid), whey lipid, cheese lipid and/or buttermilk lipid. Buttermilk lipid is typically obtained during the manufacture of buttermilk. Butter serum lipid or beta serum lipid is typically obtained during the manufacture of anhydrous milk fat from butter. Preferably the phospholipid and optionally glycosphingolipid is obtained from milk cream. Examples of suitable commercially available sources for phospholipid from milk are BAEF, SM2, SM3 and SM4 powder of Corman, Salibra of Glanbia, Lipamin M20 of Lecico and LacProdan MFGM-10 or PL20 of Arla.

The use of phospholipid from milk fat advantageously comprises the use of milk fat globular membrane (MFGM), which are more reminiscent to the situation in human milk. The concomitant use of phospholipid derived from milk and triglycerides derived from a mix of vegetable lipid and mammalian milk fat therefore enables the manufacture of coated lipid globules with a coating more similar to human milk, while at the same time providing an optimal fatty acid profile.

Preferably the phospholipid is derived from mammalian milk fat, more preferably from cow's mammalian milk fat. Preferably the phospholipid is derived from or forms part of MFGM, more preferably is derived from or forms part of cow's MFGM.

Preferably the nutritional composition comprises phospholipid and glycosphingolipid. In a preferred embodiment the weight ratio of phospholipid: glycosphingolipid is from 2:1 to 12:1, more preferably from 2:1 to 10:1 and even more preferably 2:1 to 5:1.

Methods for obtaining lipid globules with an increased size and coating with phospholipid are for example disclosed in WO 2010/027258 and WO 2010/027259.

In a preferred embodiment, the nutritional composition is a powder, preferably a powder comprising 0-5 wt. % water by weight of the nutritional composition. Preferably, the nutritional composition is in a powdered form, which can be reconstituted with water or other food grade aqueous liquid, to form a ready-to drink liquid, or is in a liquid concentrate form that should be diluted with water to a ready-to-drink liquid. It was found that lipid globules maintained their size and coating when reconstituted.

### Vitamins

The nutritional composition comprises vitamins, preferably oil soluble and/or water soluble vitamins.

Preferably, the nutritional composition comprises at least 10 μg/100 kJ of vitamins. More preferably, the nutritional composition comprises at least 50 μg/100 kJ of vitamins and more preferably the nutritional composition comprises between 100-5000 μg/100 kJ of vitamins.

Preferably, the nutritional composition comprises oil soluble vitamins, wherein the oil soluble vitamins are preferably selected from vitamin A, vitamin D, vitamin E and combinations thereof.

Preferably, at least 90wt. % of the oil soluble vitamins are present in the phospholipid coated lipid globules. More preferably at least 95 wt. %, most preferably at least 98 wt. % of the oil soluble vitamins are present in the phospholipid coated lipid globules.

Preferably, each oil soluble vitamin in the nutritional composition is present at a concentration below 1.5 mg/100 ml, when the nutritional composition is in a ready-to-drink format. More preferably, each oil soluble vitamin in the nutritional composition is present at a concentration between 0.0001-1.45 mg/100 ml, when the nutritional composition is in a ready-to-drink format.

Preferably, the wt. ratio of vitamin D (μg) to lipid (g) in the nutritional composition is below 5:1, more preferably below 3:1 and most preferably between 0.1:1 and 1:1.

Preferably, the nutritional composition comprises water soluble vitamins, more preferably the nutritional composition comprises vitamins B, most preferably the nutritional composition comprises a vitamin B selected from vitamin B1, vitamin B5, vitamin B9, vitamin B12 and combinations thereof.

Preferably the vitamin is vitamin A and is present at a concentration of 10-50 μg RE/100 kJ, more preferably at a concentration of 14-45 μg RE/100 kJ, in the nutritional composition. As used herein, “μg RE” is the unit of vitamin A as defined in GB 5009.82. The level of vitamin A is suitably determined by the test method as described in GB 5009.82.

Preferably the vitamin is vitamin D and is present at a concentration of 0.1-1.5 μg/100 kJ, more preferably at a concentration of 0.2-1.3 μg/100 kJ, in the nutritional composition. The level of vitamin D is suitably determined by the test method as described in GB 5009.82.

Preferably the vitamin is vitamin E and is present at a concentration of 0.05-1.5 mg α-tocopherol/100 KJ, more preferably at a concentration of 0.1-1.3 mg α-tocopherol/100 KJ, in the nutritional composition. As used herein “mg a-tocopherol” is as defined in GB 5009.82. The level of vitamin E is suitably determined by the test method as described in GB 5009.82.

Preferably the vitamin is vitamin B1 (thiamine) and is present at a concentration of 1-80 μg/100 kJ, more preferably at a concentration of 8-72 μg/100 kJ, in the nutritional composition. The level of vitamin B1 is suitably determined by the test method as described in GB 5009.84.

Preferably the vitamin is vitamin B5 (pantothenic acid) and is present at a concentration of 50-550 μg/100 kJ, more preferably at a concentration of 90-500 μg/100 kJ, in the nutritional composition. The level of vitamin B5 is suitably determined by the test method as described in GB 5009.210.

Preferably the vitamin is vitamin B9 (folic acid) and is present at a concentration of 1-15 μg/100 kJ, more preferably at a concentration of 2-12 μg/100 kJ, in the nutritional composition. The level of vitamin

B9 is suitably determined by the test method as described in GB 5009.211.

Preferably the vitamin is vitamin B12 and is present at a concentration of 0.01-0.5 μg/100 kJ, more preferably at a concentration of 0.02-0.4 μg/100 kJ, in the nutritional composition. The level of vitamin B12 is suitable determined by the test method as described in GB 5413.14.

Preferably, the nutritional composition comprises
i. 10-50 μg RE/100 kJ vitamin A;
ii. 0.1-1.5 μg/100 kJ vitamin D; and
iii. 0.05-1.5 mg α-tocopherol/100 kJ vitamin E.

More preferably, the nutritional composition comprises
i. 10-50 μg RE/100 kJ vitamin A;
ii. 0.1-1.5 μg/100 kJ vitamin D;
iii. 0.05-1.5 mg α-tocopherol/100 kJ vitamin E; and

one or more B vitamins selected from:
iv. 1-80 μg/100 kJ vitamin B1;
v. 50-550 μg/100 kJ vitamin B5;
vi. 1-15 μg/100 kJ vitamin B9; and
vii. 0.01-0.5 μg/100 kJ vitamin B12.

More preferably, the nutritional composition comprises
i. 10-50 μg RE/100 kJ vitamin A;
ii. 0.1-1.5 μg/100 kJ vitamin D;
iii. 0.05-1.5 mg α-tocopherol/100 kJ vitamin E;
iv. 1-80 μg/100 kJ vitamin B1;
v. 50-550 μg/100 kJ vitamin B5;
vi. 1-15 μg/100 kJ vitamin B9; and
vii. 0.01-0.5 μg/100 kJ vitamin B12.

In a preferred embodiment, the vitamin concentration in the nutritional composition, expressed in μg/100 kJ, is at most 6% reduced, after 6 months in storage at a temperature of 37±2° C. and a relative humidity of 75+5%, more preferably the vitamin concentration is 0-5% reduced, and most preferably the vitamin concentration is 0-3% reduced.

In a more preferred embodiment, the vitamin concentration for each of the aforementioned vitamins (A, D, E, B1, B5, B9 and/or B12), expressed in μg/100 kJ, is at most 6% reduced, when comparing the vitamin concentration between time point 0 months and time point 6 months, wherein the nutritional composition is air-tight packaged and stored at a temperature of 37±2° C. and a relative humidity of 75±5% during these 6 months. More preferably the vitamin concentration of the aforementioned vitamins is 0-5% reduced, and most preferably the vitamin concentration of the aforementioned vitamins is 0-3% reduced.

### Digestible Carbohydrates

The nutritional composition comprises digestible carbohydrates. The digestible carbohydrates preferably provide 25 to 75% of the total calories of the nutritional composition. Preferably the digestible carbohydrates provide 40 to 60% of the total calories. Based on calories the nutritional composition preferably comprises of 5 to 20 g of digestible carbohydrates per 100 kcal, more preferably 6 to 16 g per 100 kcal. When in liquid form, e.g. as a ready-to-feed liquid, the nutritional composition preferably comprises 3 to 30 g digestible carbohydrate per 100 ml, more preferably 5 to 20 g, even more preferably 5 to 10 g per 100 ml. Based on dry weight the nutritional composition preferably comprises 20 to 80 wt. %, more preferably 40 to 65 wt. % of digestible carbohydrates.

Preferred digestible carbohydrate sources are one or more of lactose, glucose, sucrose, fructose, galactose, maltose, starch and maltodextrin. The nutritional composition preferably comprises lactose. The nutritional composition preferably comprises digestible carbohydrate, wherein at least 35 wt. %, more preferably at least 50 wt. %, more preferably at least 75 wt. %, even more preferably at least 90 wt. %, most preferably at least 95 wt. % of the digestible carbohydrate is lactose. Based on dry weight the nutritional composition preferably comprises at least 25 wt. % lactose, preferably at least 40 wt. % lactose.

### Protein

The nutritional composition comprises protein. The protein preferably provides 5 to 20% of the total calories. Preferably the nutritional composition comprises protein that provides 6 to 12% of the total calories. Preferably the nutritional composition comprises less than 3.5 g protein per 100 kcal, more preferably the nutritional composition comprises between 1 and 3 g protein per 100 kcal, even more preferably between 1.5 and 3.0 g protein per 100 kcal. The protein concentration in a nutritional composition is determined by the sum of protein, peptides and free amino acids. Based on dry weight the nutritional composition preferably comprises less than 12 wt. % protein, more preferably between 9.6 and 12 wt. %, even more preferably between 10 and 11 wt. %. Based on a ready-to-drink liquid product the nutritional composition preferably comprises less than 2.5 g protein per 100 ml, more preferably between 1.2 and 2.5 g per 100 ml, even more preferably between 1.25 and 1.85 g per 100 ml.

The source of the protein is preferably selected in such a way that the minimum requirements for essential amino acid content are met and satisfactory growth is ensured. Hence protein sources based on cows' milk proteins such as whey, casein and mixtures thereof and proteins based on soy, potato or pea are preferred. In case whey proteins are used, the protein source is preferably based on acid whey or sweet whey, whey protein isolate or mixtures thereof. Preferably the nutritional composition comprises at least 3 wt. % casein based on dry weight. Preferably the casein is intact and/or non-hydrolyzed.

### Non-Digestible Carbohydrates

The nutritional composition preferably comprises non-digestible oligosaccharides. Preferably the nutritional composition comprises non-digestible oligosaccharides with a degree of polymerization (DP) between 2 and 250, more preferably between 3 and 60.

Preferably the nutritional composition comprises fructo-oligosaccharides, galacto-oligosaccharides and/or galacturonic acid oligosaccharides, more preferably fructo-oligosaccharides and/or galacto-oligosaccharides, even more preferably galacto-oligosaccharides, most preferably transgalacto-oligosaccharides. In a preferred embodiment the nutritional composition comprises a mixture of galacto-oligosaccharides and fructo-oligosaccharides, more preferably transgalacto-oligosaccharides and fructo-oligosaccharides. Suitable non-digestible oligosaccharides are for example Vivinal@GOS (FrieslandCampina DOMO), Raftilin@HP or Raftilose® (Orafti).

Preferably, the nutritional composition comprises 80 mg to 2 g non-digestible oligosaccharides per 100 ml, more preferably 150 mg to 1.5 g per 100 ml, even more preferably 300 mg to 1g per 100 ml. Based on dry weight, the nutritional composition preferably comprises 0.25 wt. % to 20 wt. %, more preferably 0.5 wt. % to 15 wt. %, even more preferably 1.5 wt. % to 10 wt. % of non-digestible oligosaccharides.

### Method

A second aspect of the invention preferably relates to a method for preserving vitamin in a nutritional composition, wherein the method comprises providing the nutritional composition comprising digestible carbohydrates, protein, lipid and vitamins, wherein the lipid is in the form of lipid globules and wherein the lipid globules have a mode diameter, based on volume, of at least 1.0 μm; and/or at least 45 volume %, based on total lipid volume, of the lipid globules have a diameter of 2 to 12 μm; and wherein the lipid globules stabilize the vitamins during storage.

Preferably, the invention relates to a method for preserving vitamin during the shelf-life of a nutritional composition, wherein the method comprises the steps of:
a. providing a nutritional composition selected from infant formula, follow-on formula or young child formula, said composition comprising digestible carbohydrates, protein, lipid and vitamins, wherein the lipid is in the form of lipid globules; and
   (i) wherein the lipid globules have a mode diameter, based on volume, of at least 1.0 μm; and/or at least 45 volume %, based on total lipid volume, of the lipid globules have a diameter of 2 to 12 μm; and
   (ii) wherein the lipid comprises 0.5 to 20 wt. % phospholipids based on total lipids and wherein the lipid globules are at least partly coated on the surface with phospholipids derived from mammalian milk; and
   wherein the nutritional composition comprises 10-50 wt. % vegetable lipid by weight of dry matter; and
b. packaging the provided nutritional composition in an air-tight packaging;
c. storing the packaged nutritional composition at a temperature of 10-30° C. for at least one month.

Preferably, the packaged nutritional composition is stored for at least two months, more preferably at least 4 months and most preferably is stored for 6-24 months.

The preferred embodiments described herein before for the nutritional composition with regards to the first aspect of the invention, preferably also apply to the second aspect of the invention.

### Product

A third aspect of the invention relates to a nutritional composition, wherein the nutritional composition is selected from infant formula, follow-on formula and young child formula, wherein the nutritional composition comprises digestible carbohydrates, protein, lipid and vitamins, wherein the lipid is in the form of lipid globules and wherein
a. the lipid globules have a mode diameter, based on volume, of at least 1.0 μm; and/or at least 45 volume %, based on total lipid volume, of the lipid globules have a diameter of 2 to 12 μm; and
b. wherein the lipid comprises 0.5 to 20 wt. % phospholipids based on total lipids and wherein the lipid globules are at least partly coated on the surface with phospholipids; and
c. wherein the nutritional composition comprises
   i. 10-50 μg RE/100 kJ vitamin A;
   ii. 0.1-1.5 μg/100 kJ vitamin D; and
   iii. 0.05-1.5 mg α-tocopherol/100 kJ vitamin E.

More preferably, the third aspect of the invention relates to a nutritional composition, wherein the nutritional composition is selected from infant formula, follow-on formula and young child formula, wherein the nutritional composition comprises digestible carbohydrates, protein, lipid and vitamins, wherein the lipid is in the form of lipid globules and wherein
a. the lipid globules have a mode diameter, based on volume, of at least 1.0 μm; and/or at least 45 volume %, based on total lipid volume, of the lipid globules have a diameter of 2 to 12 μm; and
b. wherein the lipid comprises 0.5 to 20 wt. % phospholipids based on total lipids and wherein the lipid globules are at least partly coated on the surface with phospholipids;
c. wherein the nutritional composition comprises 10-50 wt. % vegetable lipid by weight of dry matter; and
d. wherein the nutritional composition comprises the following shelf-life stable vitamins
   i. 10-50 μg RE/100 kJ vitamin A;
   ii. 0.1-1.5 μg/100 kJ vitamin D; and
   iii. 0.05-1.5 mg α-tocopherol/100 kJ vitamin E;
   iv. 1-80 μg/100 KJ vitamin B1;
   v. 50-550 μg/100 kJ vitamin B5;
   vi. 1-15 μg/100 kJ vitamin B9; and
   vii. 0.01-0.5 μg/100 kJ vitamin B12.

The preferred embodiments for the nutritional composition described herein before with regards to the first aspect of the invention, preferably also apply to the third aspect of the invention.

The term ‘shelf-life stable’ as used herein refers to the stability of the vitamin concentration of each shelf-life stable vitamin in the nutritional composition, which, expressed in μg/100 kJ, is at most 6% reduced for each shelf-life stable vitamin, when comparing the vitamin concentration between time point 0 months and time point 6 months, wherein the nutritional composition is air-tight packaged and stored at a temperature of 37±2° C. and a relative humidity of 75±5% during these 6 months.

Preferably, the nutritional composition further comprises vitamin B, more preferably a vitamin B selected from vitamin B1, vitamin B5, vitamin B9, vitamin B12 and combinations thereof. Even more preferably, the nutritional composition comprises:
iv. 1-80 μg/100 kJ vitamin B1;
v. 50-550 μg/100 kJ vitamin B5;
vi. 1-15 μg/100 kJ vitamin B9; and/or
vii. 0.01-0.5 μg/100 kJ vitamin B12.

Most preferably the nutritional composition comprises:
iv. 1-80 μg/100 kJ vitamin B1;
v. 50-550 μg/100 kJ vitamin B5;
vi. 1-15 μg/100 kJ vitamin B9; and
vii. 0.01-0.5 μg/100 KJ vitamin B12.

In a preferred embodiment, the vitamin concentration in the nutritional composition, expressed in μg/100 KJ, is at most 6% reduced, after 6 months in storage at a temperature of 37±2° C. and a relative humidity of 75±5%, more preferably the vitamin concentration is 0-5% reduced, and most preferably the vitamin concentration is 0-3% reduced.

Preferably, the nutritional composition is a powder comprising 0-5 wt. % water by weight of the nutritional composition.

Preferably, at least 90wt. % of oil soluble vitamins are present in the phospholipid coated lipid globules in the nutritional composition. More preferably at least 95 wt. %, most preferably at least 98 wt. % of the oil soluble vitamins are present in the phospholipid coated lipid globules.

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

### EXAMPLES

### Example 1

Two types of study formula's (Test and Control) were prepared in powder form. Both types were complete cow's milk-based infant formulas that comprised about 10.6 en % protein (intact protein with a casein and whey protein), about 51.6 en % digestible carbohydrates (mainly lactose), 37.8 en % fat and further comprised short chain galacto-oligosaccharides (source Vivinal® GOS) and long chain fructo-oligosaccharides (source Raftilin HP®) in a 9/1 w/w ratio, and minerals, vitamins, trace elements and other micronutrients as known in the art and in compliance with directives for infant formula. The two types only differed in the presence of phospholipids and in lipid globule size (Table 1).

### Control Formula

The fat component comprised mainly vegetable fat (blend of palm oil, rape seed oil, coconut oil, sunflower oil) and about 1.5 wt. % of a LC-PUFA premix (fish oil and microbial oil). No mammalian milk derived phospholipid was added. The Control formula was prepared by a standard process for preparing infant formula and therefor comprised lipid globules with a volume-based mode diameter between 0.3-0.5 μm.

### Test Formula

The fat component comprised mainly vegetable fat (blend of palm oil, rape seed oil, coconut oil, sunflower oil) and about 1.5 wt. % of an LC-PUFA premix (fish oil and microbial oil) and about 3.6 wt. % mammalian milk fat derived from butter serum powder which is rich in milk fat globule membranes comprising milk phospholipids. The lipid droplets in the Test formula had a volume-based mode diameter between 3-5 μm and a coating predominantly composed of milk phospholipids following a production process as described in WO 2013/135739. The butter serum powder was added before homogenization, which resulted in phospholipids being present in the coating of the lipid globules.

TABLE 1

| | Test | Control |
|---|---|---|
| Lipid globule size - mode diameter based | 3-5 μm | 0.3-0.5 μm |
| on volume | | |
| Volume-based percentage of lipid globules | ≥45% | <45% |
| having a diameter between 2 and 12 μm | | |
| Milk phospholipids (wt. % based on total | 1.5 | 0 |
| lipid) | | |
| Phospholipids in the coating | Yes | No |

The water-soluble vitamins were added to the aqueous phase and the fat-soluble vitamins were added to the lipid phase, before homogenization of the two phases took place. The vitamin levels were determined in three samples of each study formula, using standard methods known in the art. The average vitamin level for these samples at the beginning of storage (T0) is provided in Table 2 for both types of study formula.

TABLE 2

| | Unit/ | Test Average | Control Average |
|---|---|---|---|
| Vitamin | 100 kJ | of 3 samples | of 3 samples |
| Vitamin A | μg RE | 22.5 | 25.7 |
| Vitamin D | μg | 0.8 | 0.8 |
| Vitamin E | mg a-TE | 0.4 | 0.4 |
| Vitamin B1 | μg | 30.8 | 34.1 |
| Vitamin B12 | μg | 0.2 | 0.1 |
| Folic acid (B9) | μg | 6.5 | 6.2 |
| Pantothenic Acid (B5) | μg | 259.3 | 183.7 |

The study formula's were packaged in standard infant formula tin packaging, including a nitrogen flush before sealing, and stored for 6 months at 37±2° C. and a humidity of RH 75±5%. These conditions allow for testing the effect of storage in accelerated conditions. After these 6 months (T6) again the vitamin levels were determined in three samples of both types of study formula and the average reduction (%) in vitamin level comparing T6 with T0 were calculated (see Table 3).

TABLE 3

Average reduction (%)
100% * ((T6 − T0)/T0)

| Vitamin | Test | Control |
|---|---|---|
| Vitamin A | −2.1% | −15.4% |
| Vitamin D | −1.6% | −9.4% |
| Vitamin E | −3.4% | −15.7% |
| Vitamin B1 | 0.3% | −6.7% |
| Vitamin B12 | −5.4% | −10.6% |
| Folic acid (B9) | −1.2% | −12.8% |
| Pantothenic Acid (B5) | 0.0% | −3.6% |

The average reduction in vitamin levels is considerably lower in the Test formula compared to the Control formula. In accelerated storage conditions, the largest reduction of vitamin level was only −5.4% for vitamin B12 in the Test formula.

1. A method for preserving vitamin during shelf-life of a nutritional composition, wherein the method comprises the steps of:
a. providing a nutritional composition selected from infant formula, follow-on formula or young child formula, said composition comprising digestible carbohydrates, protein, lipid and vitamins, wherein the lipid is in the form of lipid globules; and
i. wherein the lipid globules have a mode diameter, based on volume, of at least 1.0 μm; and/or at least 45 volume %, based on total lipid volume, of the lipid globules have a diameter of 2 to 12 μm; and
ii. wherein the lipid comprises 0.5 to 20 wt. % phospholipids based on total lipids and wherein the lipid globules are at least partly coated on the surface with phospholipids derived from mammalian milk; and
wherein the nutritional composition comprises 10-50 wt. % vegetable lipid by weight of dry matter; and
b. packaging the provided nutritional composition in an air-tight packaging;
c. storing the packaged nutritional composition at a temperature of 10-30° C. for at least one month,
wherein shelf-life refers to storage of the nutritional composition in an airtight packaging at a temperature of 10-30° C.

2. The method according to claim 1, wherein the nutritional composition comprises at least 10 μg/100 kJ of vitamins.

3. The method according to claim 1, wherein the nutritional composition comprises oil soluble vitamins, preferably oil soluble vitamins selected from vitamin A, vitamin D, vitamin E and combinations thereof.

4. The method according to claim 3, wherein at least 90wt. % of the oil soluble vitamins are present in the phospholipid coated lipid globules.

5. The method according to claim 3, wherein each oil soluble vitamin in the nutritional composition is present at a concentration below 1.5 mg/100 ml, when the nutritional composition is in a ready-to-drink format.

6. The method according to claim 3, wherein the wt. ratio of vitamin D (μg) to lipid (g) in the nutritional composition is below 5:1.

7. The method according to claim 1, wherein the nutritional composition comprises a vitamin B selected from vitamin B1, vitamin B5, vitamin B9, vitamin B12 and combinations thereof.

8. The method according to claim 1, wherein the nutritional composition is airtight packaged.

9. The method according to claim 1, wherein the nutritional composition is a powder comprising 0-5 wt. % water by weight of the nutritional composition.

10. A nutritional composition, wherein the nutritional composition is selected from infant formula, follow-on formula and young child formula, wherein the nutritional composition comprises digestible carbohydrates, protein, lipid and vitamins, wherein the lipid is in the form of lipid globules and wherein
a. the lipid globules have a mode diameter, based on volume, of at least 1.0 μm; and/or at least 45 volume %, based on total lipid volume, of the lipid globules have a diameter of 2 to 12 μm; and
b. wherein the lipid comprises 0.5 to 20 wt. % phospholipids based on total lipids and wherein the lipid globules are at least partly coated on the surface with phospholipids;
c. wherein the nutritional composition comprises 10-50 wt. % vegetable lipid by weight of dry matter; and
d. wherein the nutritional composition comprises the following shelf-life stable vitamins
i. 10-50 μg RE/100 kJ vitamin A;
ii. 0.1-1.5 μg/100 kJ vitamin D;
iii. 0.05-1.5 mg α-tocopherol/100 kJ vitamin E;
iv. 1-80 μg/100 kJ vitamin B1;
v. 50-550 μg/100 kJ vitamin B5;
vi. 1-15 μg/100 kJ vitamin B9; and
vii. 0.01-0.5 μg/100 kJ vitamin B12.

11. The nutritional composition according to claim 10, wherein shelf-life stable is defined as the stability of the vitamin concentration of each shelf-life stable vitamin in the nutritional composition, which, expressed in μg/100 kJ, is at most 6% reduced for each shelf-life stable vitamin, when comparing the vitamin concentration between time point 0 months and time point 6 months, wherein the nutritional composition is air-tight packaged and stored at a temperature of 37±2° C. and a relative humidity of 75±5% during these 6 months.

12. The nutritional composition according to claim 10, wherein the nutritional composition is a powder comprising 0-5 wt. % water by weight of the nutritional composition.

13. The nutritional composition according to claim 10, wherein the nutritional composition is airtight packaged.

14. The nutritional composition according to claim 10, wherein the at least 90 wt. % of oil soluble vitamins are present in the phospholipid coated lipid globules.
